(19) United States
(12) Patent Application Publication
(10) Pub. No.: US 2024/0187676 A1
(43) Pub. Date: Jun. 6, 2024

(54) REMOTE CONTROLLABLE SMART DEVICE AND METHOD

(71) Applicant: InterDigital CE Patent Holdings, SAS, Paris (FR)

(72) Inventors: Sylvain Lelievre, Montgermont (FR); Gwenaelle Marquant, La Chapelle Chaussee (FR); Philippe Schmouker, Betton (FR); Sylvain Thiebaud, Noyal sur Vilaine (FR)

(21) Appl. No.: 18/284,634

(22) PCT Filed: Mar. 25, 2022
(86) PCT No.: PCT/EP2022/057900

§ 371 Date: Sep. 28, 2023

(30) Foreign Application Priority Data
Mar. 30, 2021 (EP) 21305401.8

(51) Int. Cl. H04N 21/422; H04N 21/41; H04N 21/436

(52) U.S. Cl. CPC H04N 21/42208; H04N 21/41265; H04N 21/436

(57) ABSTRACT

A controllable device provides through a first communication interface to a controller device, data location information indicating where user interface data can be obtained, the data location information can comprise an address of the controllable device and at least one hardware processor configured to provide, upon request from the controller device via a second communication interface, the user interface data enabling rendering of a user interface, reception of user input via the user interface and sending to the controllable device of a message corresponding to a command received through the user interface and to implement the command based on the message.

### TECHNICAL FIELD

The present disclosure relates generally to connected devices and in particular to a remote control of such devices.

### BACKGROUND

This section is intended to introduce the reader to various aspects of art, which may be related to various aspects of the present disclosure that are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Smart devices, i.e., devices that are connected to or able to connect to network, provide certain advantages to their users. A user or other devices can for example connect with smart devices via a network connection. Most smart devices can also obtain new functionality. Examples of smart devices include cars, thermostats, refrigerators, ovens and televisions.

Taking the examples of televisions, a smart television can typically propose different applications such as TV channel watching, Video on Demand (VOD), replay, web browsing and games.

However, interacting with smart devices is not always easy. A salient example is televisions for which conventional remote controls tend to be ill fitted for a user to interact with one or more functions of the television. In this case, it may be necessary for the user to go through menu trees or use complex combinations of buttons to perform a given action.

One existing solution to this problem is to download and use an app on a smartphone, which typically requires the smart device and the smartphone to be connected to the same Wi-Fi network. Downloading such an app can be facilitated using a Near-Field Communication (NFC) tag on the smart device or by scanning a QR code displayed on a screen of the smart device.

However, even if the user is automatically “directed” to the app site, the app must still be installed manually. In addition, the app remains on the smartphone once the interaction is over. Further, conventional solutions can require proprietary technology compatibility between the smartphone and the smart device.

It will thus be appreciated that there is a desire for a solution that addresses at least some of the shortcomings of interaction with smart devices. The present principles provide such a solution.

### SUMMARY OF DISCLOSURE

In a first aspect, the present principles are directed to a controllable device including a first communication interface configured to provide, to a controller device, information indicating a data location where user interface data can be obtained, and at least one hardware processor configured to upon a request received at the data location, provide, via a second communication interface to the controller device, the user interface data enabling rendering of a user interface by the controller device, and receive, from the controller device via a third communication interface, a message corresponding to a command received through the user interface.

In a second aspect, the present principles are directed to a method in a controllable device including providing, via a first communication interface to a controller device, information indicating a data location where user interface data can be obtained, upon a request received at the data location, providing, via a second communication interface to the controller device, the user interface data enabling rendering of a user interface by the controller device, and receiving, from the controller device via a third communication interface, a message corresponding to a command received through the user interface.

In a third aspect, the present principles are directed to a computer program product which is stored on a non-transitory computer readable medium and includes program code instructions executable by a processor for implementing the steps of a method according to any embodiment of the second aspect.

### BRIEF DESCRIPTION OF DRAWINGS

Features of the present principles will now be described, by way of non-limiting example, with reference to the accompanying drawings, in which:

FIG. 1 illustrates a system according to an embodiment of the present principles;

FIG. 2 illustrates a flow chart of a method of an embodiment of the present principles; and

FIG. 3 illustrates a flow chart of a method for limiting interaction in time according to an embodiment of the present principles.

### DESCRIPTION OF EMBODIMENTS

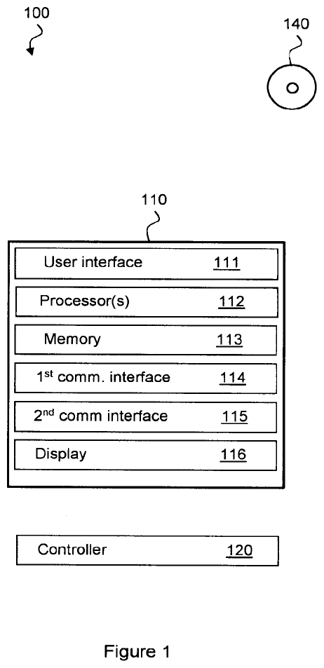

FIG. 1 illustrates a system 100 according to an embodiment of the present principles. The system 100 includes a smart device 110 and a controller 120. As a non-limiting example, the smart device will be described as a television. It should be understood that the smart device can be of practically any type, e.g. another type of content renderer, an oven, a refrigerator or a light bulb; all the features described for the television may not be included in another kind of smart device.

The smart device 110 typically can include a user interface (UI) 111, at least one hardware processor (“processor”) 112, memory 113, a first communication interface 114, a second communication interface 115 and a display 116.

The user interface 111 is configured to receive inputs (e.g. commands) from a user, either directly (e.g. through buttons or a touch screen) or indirectly from a user interface unit such as a conventional remote control (not shown).

The processor 112 is configured to execute program code instructions to perform a method according to the present principles.

The memory 113, which can be at least partly non-transitory, is configured to store the program code instructions to be executed by the processor 112, parameters, image data, intermediate results and so on.

The first communication interface 114 is configured for transmitting UI data location information to the controller 120, as will be further described. The first communication interface 114 can implement any suitable technology, wired or wireless or a combination of the two; examples include an NFC interface and a QR code (e.g., shown on the display 116 or printed in a place where it is readable by the controller).

The second communication interface 115 is configured for communication with devices over a network, e.g., a WiFi network or the Internet.

The display 116 is configured to display information destined for the user. On a television, the display 116 can also be configured to display conventional content, menus etc.

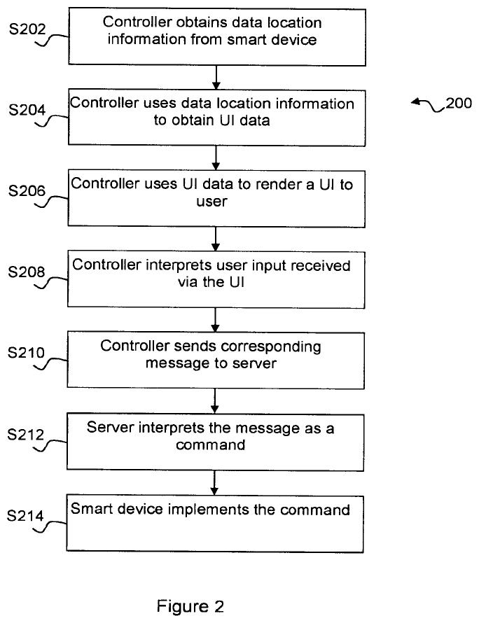

The controller 120 can for example be a conventional smartphone, a tablet or a ‘universal’ remote control equipped with the functionality described with reference to FIG. 2.

A non-transitory storage medium 140 stores computer-readable instructions that, when executed by a processor, perform a method according to an embodiment of the present principles.

FIG. 2 illustrates a method 200 of an embodiment of the present principles.

In step S202, the controller 120 interacts with the first communication interface 114 in a manner dependent on the technology used. For example, if the first communication interface 114 is a Near-Field Communication (NFC) tag, then the controller 120 interacts with the NFC tag through a NFC reader when the user puts the reader within sufficient proximity of the tag. If the first communication interface uses a QR code, then the controller interacts through a camera and a QR code detector and interpreter when the user aims the camera at the QR code and triggers interpretation. Other possibilities include text recognition and wireless broadcasting.

During the interaction, data location information is transferred to the controller 120. The UI data location information, which can for example be a Uniform Resource Locator (URL) or an Internet Resource Locator (IRL), indicates where (e.g., at which address) the UI data can be obtained. It is noted that the UI data typically does not refer to the user interface 111 of the smart device 110; while these may have at least partly similar functionality, they are typically distinct. In an alternative, the smart device displays the data location information so that it can be manually entered on the controller 120 by the user.

The data location information can be dynamically provided to the first communication interface 114 by the processor 112, thus enabling different data location information to be provided to the controller 120 at different times.

In other words, in step S202, the controller obtains the data location information provided by the smart device 110.

In step S204, resident software on the controller 120 uses the UI data location information to obtain the UI data, which upon request can be provided by the smart device 110. In an embodiment, the resident software is a web browser that, as is well known, can use the URL to download the information on that web page. Other ways that employ addressing information to obtain data from a networked device may also be used.

In an embodiment, UI data are located in the memory 113 of the smart device 110. The smart device 110 can thus control the UI data, for example to update it to replace, add and/or remove information. In an embodiment, the UI data can be provided and/or modified by a downloaded program running on the smart device 110.

The UI data allows generation of a user interface by the controller. In an embodiment, the user interface is a graphical user interface (GUI).

In step S206, the resident software on the controller 120 displays formatted UI data to the user in the form of a user interface that can include one or more interactive objects such as buttons, widgets, menus and a virtual keyboard. Formatting data for display—for example formatting a HTML data (by a web browser), Java bytes code (by a Java virtual machine (VM)) or Python scripts (in a Python environment)—is well known in the art. It will be understood that other ways of rendering the user interface, such as via speech, are possible; displaying is just an example.

The user interface can for example mimic a conventional TV remote control with buttons (if that is appropriate), but one skilled in the art will appreciate that a more sophisticated user interface with widgets and sub-menus is possible. A TV user interface can for instance include arrow keys to navigate in a media gallery, channel buttons (e.g., up and down), volume buttons and a keyboard to enter text in a web browser.

An interactive object is associated with an action. Different interactive objects are typically associated with different actions, but it is also possible for interactive objects to be associated with a single action. An action can for example be sending a command, one or more steps when navigating a menu, and entering text.

In step S208, the controller 120 receives user input, e.g., a command, via the displayed user interface. The resident software interprets the user input and obtains its associated action, as is well known in for example web browsers.

In step S210, the resident software of the controller 120 sends a message related to the action to the smart device 110.

For example, a button in a displayed web page can include an address (e.g., a URL) that links to the smart device 110; activation of the button will cause a message, for instance, an HTTP request or a Web Socket (WS) message, to be sent to the smart device 110. As different interactive objects can be associated with different actions, different interactive objects can cause transmission of different messages to the smart device 110.

In an embodiment, the address is of a server and includes an action-specific suffix. The server can be run by the smart device 110. The address can also indicate an intermediary device, such as a WiFi router or a server, with which the smart device is registered and that, upon interpreting the message to be related to a specific device (e.g., the smart device 110) translates the address, e.g. using an identifier in the action, to that of the server running on the smart device 110. The server can also run on a device, e.g., a decoder, that interprets the messages and sends corresponding interpreted messages to the smart device, for example using High-Definition Multimedia Interface (HDMI) Consumer Electronics Control (CEC) technology.

In step S212, the server receives and interprets the message from the controller 120 as a command. If the server is not hosted by the smart device 110, then the server determines a corresponding command to send to the smart device 110.

As mentioned, the message can for example be a HTTP request or a Web Socket message that can be interpreted as a command resulting from an option provided by the user interface on the controller.

In step S214, the smart device 110 implements the command. Implementation can be direct, by the smart device 110, or indirect, by software such as an application executing on the smart device 110. In the latter case, the smart device 110 provides the command to the software.

As can be seen, there is no need for specialised software running on the controller 120 as the present principles can be implemented on the controller using conventional technology. As such, the memory requirements of the controller can be less than for example on a device that installs specialised software. Indeed, after interaction with the smart device, the controller according to the present principles can store little, even close to no data, typically in a cache and/or browser history.

In an embodiment, the user interface can depend on a state of the smart device, where the state for example can depend on the type of application currently executed by the smart device. Thus, for a television, a first user interface could be used when watching live television, a second user interface when using the television to surf the Internet, and so on. UI data for a second user interface can be transferred to the controller in a response to a command (e.g., a selection in a menu) entered using a first user interface. The UI data for the second user interface can also be provided to the controller upon interaction with the first communication interface, as described with reference to step S202 of FIG. 2. For a television or other content renderer, UI data can also be provided by the currently rendered content, such as a broadcast program, which for example can allow interaction with the content.

In the case of, for instance, different applications downloaded to the smart device, each application can embark or otherwise provide its own UI data to be transferred by the smart device to the controller.

In an embodiment, the server hosts a web socket (WS) server to connect the smart device or the smart device application on the one hand and the resident software using the UI data on the other hand as connected clients.

In an embodiment, a plurality of users can have controllers that interact, even simultaneously, with the smart device. Each user can obtain UI data as already described. To differentiate the users, the smart device can provide different UI data to each user so that each controller provides a different identifier, but it is also possible to use the same UI data provided that the controller or user is otherwise identified, for example using an identifier of the controller such as an IP address.

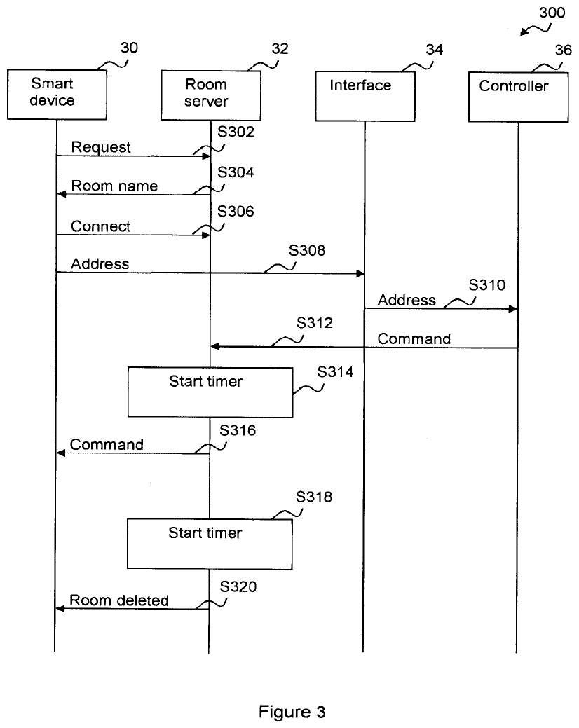

In an embodiment, interaction between the controller and the smart device can be limited in time. FIG. 3 illustrates such a method 300 that for example be achieved by implementing a temporary chat room mechanism inside a web socket as follows: 1) The smart device 30 sends S302 a “Room Request” to a “Room” Server 32. 2) Upon reception of the request, the server generates a random number (rnd) and creates a new room with a name being a function of rnd: Rname=f(rnd). 3) The server 32 sends the room name S304 to the software in the smart device 30 that initiates a connection S306 to the room. 4) The software provides S308 data location information, including the room name as a parameter, to the first communication interface 34. 5) The controller 36 interacts S310 with the first communication interface 34, leading the UI to be rendered. The UI allows sending messages to the software via the room and the room server. 6) Upon reception S312 of the first message, “Command”, in the room, the server 32 starts a timer S314 to limit the opening of the room and the server 32 forwards S316 a corresponding command to the smart device 30. After expiration of the timer S318, the room is closed S320; no further messages can be communicated via the room. 7) A new room can be created on any request.

In an embodiment, interaction between the controller and the smart device can be limited in distance. This can for example be achieved by implementing the communication between the smart device and the controller over Bluetooth. Due to the low range of Bluetooth, the controller will lose the connection with the smart device when out of range. Proximity detection can also be achieved using RSSI (Received Signal Strength Indication) during Bluetooth scanning phase. When the controller renders the UI, it opens a connection to a room, providing as a parameter its Bluetooth ID. The smart device is then able to try a Bluetooth connection and to measure the RSSI to infer the distance of the controller. The smart device can then ignore messages from a controller that is determined to be too far away.

As another example, the smart device is an oven that can have a very limited display or no display at all. Providing a UI to the controller can provide an easier way, and/or at a distance, to input commands that also can be input using the oven's own UI. It is also possible to provide a more advanced user interface that for example can propose pre-defined cooking options for a set of meals.

It will thus be appreciated that the present principles can be used to provide a dynamic user interface that can have a small footprint on a controller.

It should be understood that the elements shown in the figures may be implemented in various forms of hardware, software, or combinations thereof. Preferably, these elements are implemented in a combination of hardware and software on one or more appropriately programmed general-purpose devices, which may include a processor, memory, and input/output interfaces.

The present description illustrates the principles of the present disclosure. It will thus be appreciated that those skilled in the art will be able to devise various arrangements that, although not explicitly described or shown herein, embody the principles of the disclosure and are included within its scope.

All examples and conditional language recited herein are intended for educational purposes to aid the reader in understanding the principles of the disclosure and the concepts contributed by the inventor to furthering the art, and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams presented herein represent conceptual views of illustrative circuitry embodying the principles of the disclosure. Similarly, it will be appreciated that any flow charts, flow diagrams, and the like represent various processes which may be substantially represented in computer readable media and so executed by a computer or processor, whether such computer or processor is explicitly shown or not.

The functions of the various elements shown in the figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, read only memory (ROM) for storing software, random access memory (RAM), and non-volatile storage.

Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

In the claims hereof, any element expressed as a means for performing a specified function is intended to encompass any way of performing that function including, for example, a) a combination of circuit elements that performs that function or b) software in any form, including, therefore, firmware, microcode, or the like, combined with appropriate circuitry for executing that software to perform the function. The disclosure as defined by such claims resides in the fact that the functionalities provided by the various recited means are combined and brought together in the manner which the claims call for. It is thus regarded that any means that can provide those functionalities are equivalent to those shown herein.

Amendments to and listing of the claims:

1. A controllable device comprising:
a first communication interface configured to provide, to a controller device, information indicating a location where data can be obtained, the data enabling rendering of a user interface by the controller device; and
at least one hardware processor configured to:
based on a request from the controller device and received at the location, provide the data to the controller device via a second communication interface; and
receive, from the controller device via a third communication interface, a message corresponding to a command received by the controller device through the user interface.

2. The controllable device of claim 1, wherein the information indicating the location comprises an address of the controllable device.

3. The controllable device of claim 2, wherein the address is one of a uniform resource locator and an internet resource locator.

4. The controllable device of claim 1, wherein the first communication interface is a near-field communication tag.

5. The controllable device of claim 1, wherein the data comprises at least one of a hypertext markup language web page, a Java program and a Python script.

6. The controllable device of claim 1, wherein the message is one of a HTTP hypertext transfer protocol request and a web socket message.

7. The controllable device of claim 1, wherein the data depends on at least one of an application executed by the controllable device and a content rendered by the controllable device.

8. The controllable device of claim 1, wherein the at least one hardware processor is further configured to use respective identifiers of controller devices to differentiate between messages received from a plurality of controller devices.

9. The controllable device of claim 1, wherein the at least one hardware processor is further configured to implement a time limit for interaction with the controller device.

10. The controllable device of claim 1, wherein the at least one hardware processor is further configured to implement a distance limit for interaction with the controller device.

11. The controllable device of claim 1, further comprising a server configured to receive the message at an address provided with the data.

12. The controllable device of claim 1, wherein the at least one hardware processor is further configured to implement the command based on the message.

13. The controllable device of claim 1, wherein the second communication interface and the third communication interface are implemented in a single communication interface.

14. A method in a controllable device comprising:
providing, via a first communication interface to a controller device, information indicating a location where data can be obtained;
based on a request received at the location, providing the data to the controller device via a second communication interface, the data enabling rendering of a user interface by the controller device; and
receiving, from the controller device via a third communication interface, a message corresponding to a command received through the user interface.

15-18. (canceled)

19. The method of claim 14, wherein the data depends on at least one of an application executed by the controllable device and a content rendered by the controllable device.

20. The method of claim 14, further comprising using respective identifiers of controller devices to differentiate between messages received from a plurality of controller devices.

21. The method of claim 14, further comprising implementing a time limit for interaction with the controller device.

22. The method of claim 14, further comprising implementing a distance limit for interaction with the controller device.

23. The method of claim 14, further comprising implementing the command based on the message.

24. A non-transitory computer-readable storage medium storing instructions that, when executed by at least one hardware processor, cause at least one hardware processor to:
provide, via a first communication interface to a controller device, information indicating a location where data can be obtained;
upon a request received at the location, provide, via a second communication interface to the controller device, the data enabling rendering of a user interface by the controller device; and
receive, from the controller device via a third communication interface, a message corresponding to a command received through the user interface.
